(19) United States
(12) Patent Application Publication
(10) Pub. No.: US 2003/0152154 A1
(43) Pub. Date: Aug. 14, 2003

(54) Coding and decoding system and method for high-speed data transmission

(76) Inventor: Ryan C. Johnson, Waconia, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/076,904

(22) Filed: Feb. 14, 2002

(51) Int. Cl. H04L 27/00

(52) U.S. Cl. 375/259

(57) ABSTRACT

This document discusses high speed data communication systems and methods, such as for communicating symbols using pulse-amplitude-modulated (PAM) or other multilevel (i.e., more than two) signal levels (e.g., PAM5 symbols using five signal levels). One example encodes and/or decodes between n-bit blocks of binary data (e.g., n=12) and m-symbol code words (e.g., m=6 PAM5 symbols). In this example, the code words are selected to limit the runlength of consecutive symbols transmitted without a symmetric-about-baseline transition between signal levels. In another example, the code words bound a word disparity representing a cumulative deviation from baseline of the values of the symbols of the code words. In a further example, the code words bound an intraword disparity representing a symbol-by-symbol cumulative deviation from baseline, within the code word. Symmetric code words with the same amount, but opposite signs, of nonzero word disparity are paired and together mapped to a unique code of the n-bit block of binary data. During communication, a running disparity is computed, and the code word of the pair that will reduce the running disparity is communicated. Word boundaries are discerned by communicating a nondata control word. In one example, the code or control words are selected to improve immunity to single symbol transmission error. In another example, error checking is performed using the word and running disparities.

### TECHNICAL FIELD

This document relates generally to high-speed data transmission systems and methods, and particularly, but not by way of limitation, to a coding and decoding system and method for high-speed data transmission.

### BACKGROUND

High-speed data transmission over electromagnetic or optical transmission line media sometimes requires particular data coding or decoding techniques to compensate for limitations of the transmission media, which may have characteristics that deviate from the ideal at high data rates. Such non-ideal characteristics may manifest themselves during high-speed data transmission over relatively short distances (e.g., between components mounted on a backplane or other printed circuit) as well as for high-speed data transmission over much longer distances. For example, an AC-coupled electromagnetic transmission line may be exhibit a DC or slowly-varying voltage that depends on the particular data being transmitted. This can inhibit reliable data reception. For binary data transmission, which uses two possible signal levels for each transmitted data bit, a encoding/decoding scheme such as 8B/10B ensures charge-balanced data transmission, thereby avoiding data-dependent charging or discharging of the electromagnetic transmission line. See, e.g. “A DC-Balanced, Partitioned-block, 8B/10B Transmission Code” by A. X. Widmer et al., IBM J. Res. Develop., vol. 27, No. 5, Sep. 1983, pp. 140-151. The 8B/10B scheme encodes an 8-bit input word (having 2⁸=256 codes) into a 10-bit transmitted word (having 2¹⁰=1024 codes), which is then received and decoded back into an 8-bit output word. This redundancy permits selection of those code words that support an equal number of transmitted “ones” and “zeros,” by discarding other code words that would cause an unequal number of transmitted “ones” and “zeros.” Among the things that the present inventors have recognized, binary data transmission limits data transmission bandwidth because it uses only two signal levels. For these and other reasons, the present inventors have recognized that there exists an unmet need for coding and decoding techniques for even higher-speed data transmission involving multilevel signaling (i.e., more than two signal levels for each transmitted data symbol).

### BRIEF DESCRIPTION OF THE DRAWINGS

In the drawings, which are offered by way of example, and not by way of limitation, and which are not necessarily drawn to scale, like numerals describe substantially similar components throughout the several views. Like numerals having different letter suffixes represent different instances of substantially similar components.

FIG. 1 is a schematic/block diagram illustrating generally one example of a high-speed data communication system for communicating data over an electromagnetic, optical, or other transmission line.

FIG. 2 is an amplitude vs. time graph illustrating generally one example of a multilevel signal communicated over transmission line.

FIG. 3 is a block diagram illustrating generally one example of encoder encoding binary input data into multilevel output data for transmission over a transmission line.

FIG. 4 is a flow chart illustrating generally one example of a method of selecting valid candidate code words from possible code words.

FIG. 5 is a flow chart illustrating generally, by way of example, but not by way of limitation, a method of selecting and designating one or more control/comma words/pairs.

FIG. 6 is a flow chart illustrating generally, by way of example, but not by way of limitation, one technique for selecting actual code words for data communication from candidate valid code words obtained as illustrated in FIG. 4.

FIG. 7 is a schematic/block diagram illustrating generally, by way of example, but not by way of limitation, one example of portions of an encoder.

FIG. 8 is a schematic/block diagram illustrating generally, by way of example, but not by way of limitation, one example of portions of a decoder.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents.

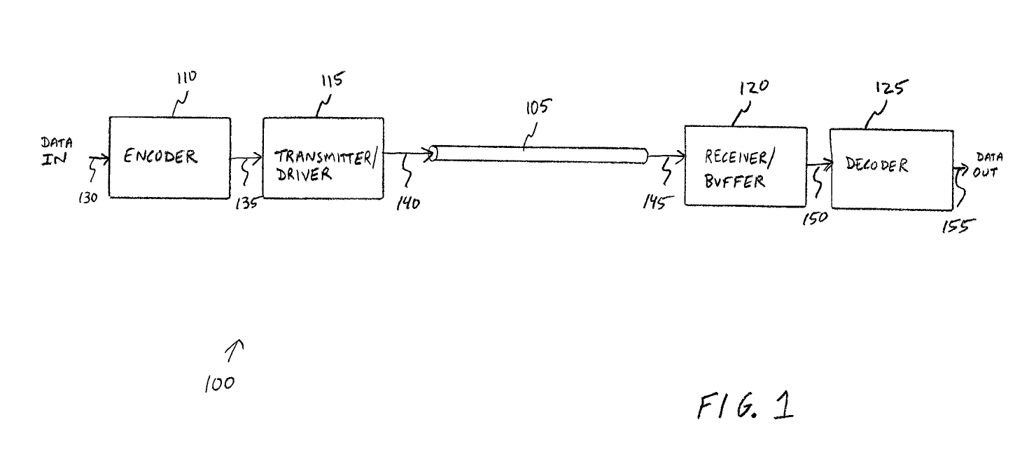

FIG. 1 is a schematic/block diagram illustrating generally one example of a high-speed data communication system 100 for communicating data over an electromagnetic, optical, or other transmission line 105. In one example, transmission line 105 provides high-speed data communication over a relatively short distance (e.g., between components mounted on a backplane or other printed circuit in a computer or other apparatus). In another example, transmission line 105 provides high-speed data communication over much longer distances. In the example of FIG. 1, system 100 includes an encoder 110, a transmitter/driver 115, a receiver 120, and a decoder 125. Binary input data, at node 130, is received at an input of encoder 110, where it is encoded into a multilevel representation (i.e., more than two signal levels for each transmitted data symbol) to provide one or more desirable characteristics during communication over line 105. An output of encoder 110, at node 135, provides a representation of the data, encoded for multilevel signaling, to an input of transmitter 115. An output of transmitter 115, at node 140, sends a multilevel signal, representing the encoded data, over transmission line 105, where it is received, at node 145, by an input of receiver 120. An output of receiver 120, at node 150, provides a received binary-encoded multilevel representation of the data to decoder 125, where the multilevel symbols are decoded and provided as decoded binary output data at node 155.

Although FIG. 1 illustrates unidirectional data communication, for illustrative clarity, in one example, system 100 similarly provides bidirectional data communication by substituting a coder/decoder (“codec”) for each of encoder 110 and decoder 125 (where the codec includes both a encoder 110 and decoder 125) and using a transceiver for each of transmitter 115 and receiver 120, and using a known data communication protocol to arbitrate the direction in which data is communicated. In the example of FIG. 1, transmitter 115 and receiver 120 need not be synchronized by a master clock communicated to both. Instead, receiver 120 synchronizes itself to transmitter 115, such as by using a phase-locked loop (PLL) circuit, by extracting a synchronizing clock signal from the actual data it receives over transmission line 105.

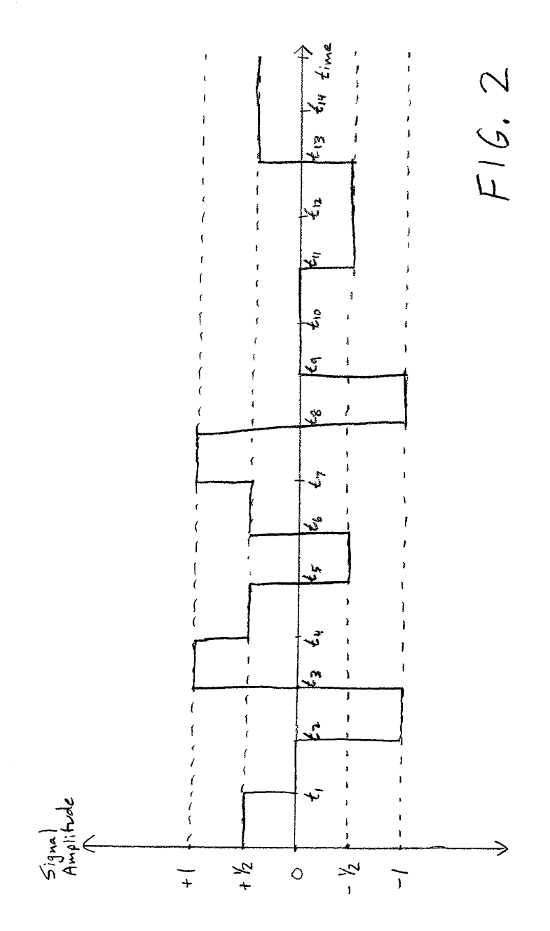

FIG. 2 is an amplitude vs. time graph illustrating generally one example of a multilevel signal communicated over transmission line 105. The example of FIG. 2 illustrates a multilevel signal using pulse amplitude modulation having five signal levels (“PAM5”) possible for each communicated symbol. In this example, the five signal levels are designated (+1, +½, 0, −½, −1), representing corresponding voltage amplitudes of (+100 mV, +50 mV, 0 V, −50 mV, −100 mV), however, other signal level designations and/or signal amplitudes may be substituted. In FIG. 2, each time interval (e.g., t₂−t₁) represents communication of a single PAM5 symbol. Each PAM5 symbol includes one of the five signal levels. The inverse of each time interval (e.g., (t₂−t₁)⁻¹) represents the PAM5 symbol communication rate. Each of the designated transition times (e.g., t₁, t₂, etc.) corresponds to a possible transition between signal levels (not all successive symbols will cause a signal level transition). Although, for conceptual clarity, FIG. 2 illustrates uniform signal levels and transition times and sharp signal transitions, the characteristics of transmitter 115, transmission line 105, and receiver 120 will, in practice, cause deviations from the illustration of FIG. 2.

Because a multilevel signal, such as PAM5, includes more signal levels than a binary signal, communicating multilevel symbols at the same communication rate as binary symbols is capable of communicating more information. Alternatively (or additionally), the additional signal levels provided by the multilevel symbols are, in one example, used to implement a coding scheme that obtains other benefits. Such possible benefits include, by way of example, but not by way of limitation, accommodating certain characteristics of transmission line 105 and/or receiver 120, providing redundancy, providing clockless data synchronization, and/or providing other desirable communication characteristics.

For example, receiver 120 may be sensitive to baseline wander, that is, a nonzero (for a baseline centered about zero) or noncentered cumulative sum of the analog signal amplitudes of the communicated symbols. In another example, receiver 120 may be sensitive to shorter-term variations in the moving sum of the signal amplitude away from the baseline over a particular moving window (e.g., over a particular time period or a particular number of communicated symbols). In addition to such sensitivity to cumulative baseline wander and shorter-term variations, because receiver 120 extracts a clock from its received data, it may require a certain number (or type) of signal level transitions to occur within a specified time period, or a specified number of received data symbols. As an example of a particular type of signal level transition that may be particularly useful for a particular design of receiver 120 in order to extract a clock, a certain number signal amplitude transitions that are symmetric about baseline may be desired to occur during a specified time period, as discussed below. Where the baseline is zero, a symmetric about baseline transition is referred to as a symmetric about zero transition (“SAZ”, e.g., from −1 to +1, from +1 to −1, from −½ to +½, or from +½ to −½).

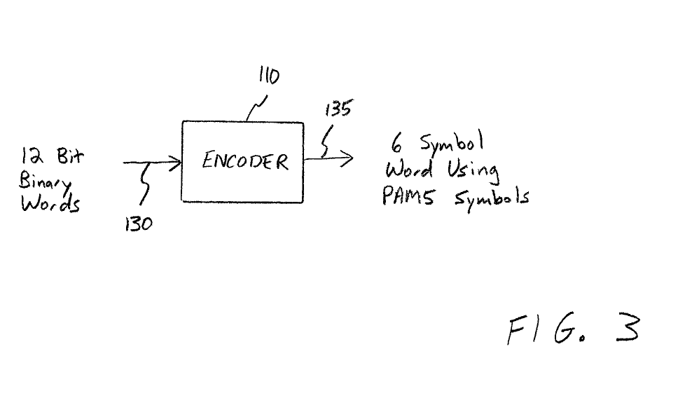

FIG. 3 is a block diagram illustrating generally one example of encoder 110 encoding binary input data into multilevel output data for transmission over transmission line 105. In this example, encoder 110 serially block-encodes 12-bit binary input words into corresponding 6-symbol output words using PAM5 symbols. Each 12-bit binary input word corresponds to 2¹²=4096 codes. Each 6-symbol PAM5 output word corresponds to 5⁶=15,625 possible codes. The excess of possible codes provided by each 6-symbol PAM5 output word over the corresponding 12-bit binary input word permits selection of an actual code subset from the possible codes provided by each 6-symbol PAM5 output word. In one example, the particular actual codes of the 6-symbol PAM5 output words are selected to provide one or more desirable characteristics during communication. Examples of such characteristics are described below, for illustrative purposes only, and not by way of limitation.

### Examples of Some Characteristics Obtainable By Selecting Appropriate Codes

1. DC/Low Frequency Balance. In one example, in order to reduce or avoid data-dependent charging and/or discharging of transmission line 105, the particular codes of the 6-symbol PAM5 output word are selected such that, over a large number of communicated PAM5 symbols, the average communicated analog signal amplitude is zero (no baseline wander). One approximation of baseline wander is the communicated signal's digital sum variance (“DSV”), which is the peak-to-peak difference of the cumulative sum over the entire data transmission session of the assigned signal level values (e.g., +1, +½, 0, −½, −1) of the communicated symbols. In one example, but not by way of limitation, the systems and methods discussed in this document obtain a DSV=7, which is comparable to a DSV=6 for the 8B/10B binary data communication scheme.

2. Deterministically-Controlled Deviation From Baseline. In another example, in order to reduce or avoid data-dependent charging and/or discharging of transmission line 105, the particular codes of the 6-symbol PAM5 output word are selected so as to deterministically control deviations from baseline (e.g., zero). Deviation from baseline is also referred to herein as “disparity.” One measure of disparity is referred to as “running disparity” over the communication session, which is the difference from baseline of the cumulative sum over the entire data transmission session of the assigned signal level values (e.g., +1, +½, 0, −½, −1) of the communicated symbols. Another measure of disparity is referred to as “word disparity,” which is the difference from baseline of the cumulative sum of a transmitted data word (which, in this example, includes six PAM5 symbols) of the assigned signal level values (e.g., +1, +½, 0, −½, −1) of the communicated symbols.

3. Bounded Run-Length or Defined Transition Density. In another example, for enhancing clock extraction from the data by receiver 120, the particular codes of the 6-symbol PAM5 output word are selected for a particular upper bound on the run-length, that is, the number of sequentially communicated symbols without a SAZ transition. Among other things, this defines a particular transition density, that is, a lower bound on the number of SAZ transitions over a particular number of successively-communicated symbols. Although, in this example, run-length is defined with respect to a SAZ transition, in an alternative example, run-length could be defined with respect to any transition between signal levels associated with successively-communicated symbols.

4. Robust Control Word. In one example, the particular codes of the 6-symbol PAM5 output word are selected to provide at least one extra word, referred to herein as a “control word” or “comma.” In one example, the control word is communicated to provide a reference point that synchronizes the data stream received by receiver 120 to that transmitted by transmitter 115. This aligns the boundaries of the received words to those the transmitted words for proper decoding. In one further example, but not by way of limitation, it also allows one or more data-dependent indicia to be independently computed at transmitter 115 and receiver 120, each referenced to (e.g., or reset by) the control word, such as for coordinating independent but mutually-understood data coding and decoding, error-correction, etc. In one example, but not by way of limitation, where the communicated words comprise six PAM5 symbols, the control word is deemed robust if at least two of its six symbols are different from all of the 6-symbol PAM5 words being used for communicating actual data, and where no two successive 6-symbol PAM5 words form the control word within their various 6-symbol substrings.

### Example of Selecting Candidate Code Words From Possible Code Words

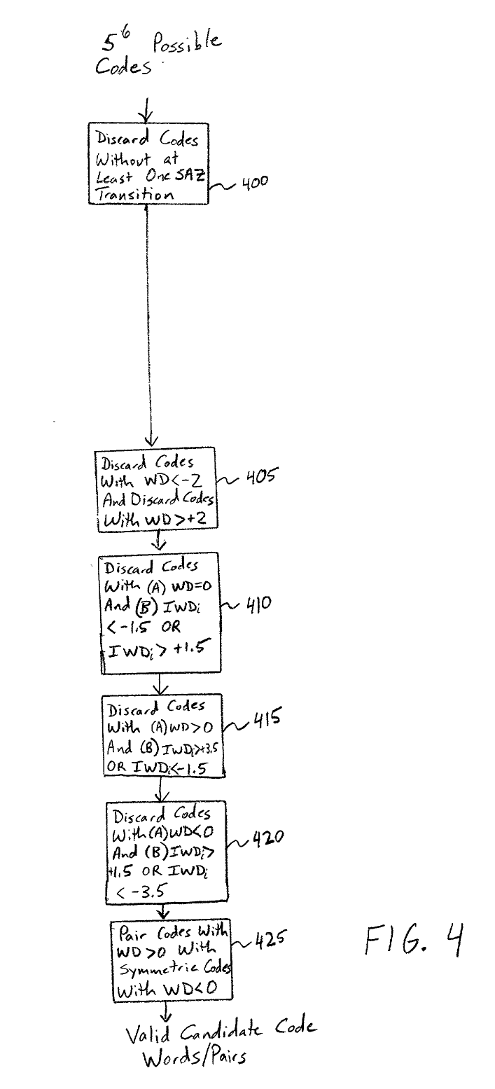

FIG. 4 is a flow chart illustrating generally one example of a method of selecting valid candidate code words from possible code words. In general, because a PAM5 symbol includes 5 possible states, a word formed of m PAM5 symbols includes 5^{m} possible codes. For illustrative clarity, FIG. 4 focuses on the case where m=6, however, in alternate embodiments, the method described in FIG. 4 is analogously applied to a word having greater or fewer symbols. Also for illustrative clarity, FIG. 4 focuses on the case where the signal levels used are +1, +½, 0, −½, and −1, as illustrated in FIG. 2. However, in alternative embodiments, the method described in FIG. 4 is analogously be applied to signal levels referenced to other values. In the example of FIG. 4, particular ones of the 5⁶ possible codes are selected as candidates, such as to obtain one or more of the characteristics described above.

At 400, codes without at least one SAZ transition are eliminated from further consideration. For example, a code of (+1, −1; 0, 0, 0, 0) would be kept for further consideration because it includes a SAZ transition from +1 to −1. However, a code of(−½, 0, +½, +1, +½, 0, −½) would be eliminated from further consideration because it lacks at least one SAZ transition. For a receiver 120 that extracts a clock from the received data signal using SAZ transitions, this ensures a maximum run-length of consecutive symbols between SAZ transitions of no more than 10 symbols, in this example.

Alternatively, such as where the code words use more than 6 PAM5 symbols per code word, a run length from start (“RLFS,” i.e., the number of consecutive symbols from the beginning of the code word without a SAZ transition) and a run length from end (“RLFE,” i.e., the number of consecutive symbols from the end of the code word without a SAZ transition) are defined. In one such example, codes with a RLFS >6 or a RLFE>5 are eliminated from further consideration. In another example, codes with a RLFE>6 or a RLFS >5 are elimnated from further consideration. Each of these two examples provides at least one SAZ transition within every 12 symbols in the encoded symbol stream.

At 405, those codes with a word disparity (“WD”) less than −2 and those codes with a WD exceeding +2 are eliminated from further consideration. The WD measures the cumulative deviation from baseline over an entire code word. Where the baseline is zero, as for the signal levels illustrated in FIG. 2, the WD is the sum of the symbol values within the code word. For example, a code of (+1, +1, −1, −1, −1, −1) has a WD=1+1−1−1−1−1=−2. In another example, a code of (0, −½, +1, −½, −½, 0) has a WD=0−½+1−½−½+0=−½. These codes would be retained, at 405, for further consideration. However, a code of (+1, −1, −1, −1, −1, −1), which has a WD=−4, would not be retained because its WD is less than −2.

At 410, those codes with zero word disparity (WD=0) are, in this example, further examined for possible elimination from further consideration based on their intraword disparity (“IWD”). The IWD of a code word measures the symbol-by-symbol cumulative deviation from baseline, within the code word. For example, a code word of (+1, +1, −1, −1, 0, 0) has WD=0. The symbol-by-symbol cumulative deviation from baseline within this code word is IWD=(+1, +2, +1, 0, 0, 0).

At 410, codes with WD=0 and IWDᵢ<−1.5 (where IWDᵢ is evaluated at every symbol within the code word) are eliminated from further consideration, in this example. Also at 410, codes with WD=0 and IWDᵢ>+1.5 are eliminated from further consideration, in this example. Therefore, the above exemplary code of (+1, +1, −1, −1, 0, 0) would be eliminated from further consideration because it has a WD=0 and an IWD=(+1, +2, +1, 0, 0, 0). Therefore, when evaluated at every symbol within the code word, IWDᵢ=2 (in this example, for i=2), which exceeds the upper bound cutoff value of IWDᵢ>+1.5.

At 415, those codes with WD>0 are, in this example, further examined for possible elimination from further consideration based on their IWD. At 415, codes with WD>0 and IWDᵢ>+3.5 are eliminated from further consideration, in this example. Also at 415, codes with WD>0 and IWDᵢ<−1.5 are eliminated from further consideration, in this example. For example, a code word of (−1, −1, +1, +1, +1, +1) has WD=+2 and IWD=(−1, −2, −1, 0, +1, +1). Because IWDᵢ=−2 ( in this example, for i=2), which falls below the lower bound cutoff value of −1.5, this code would be eliminated from further consideration.

At 420, those codes with WD<0 are, in this example, further examined for possible elimination from further consideration based on their IWD. At 420, codes with WD<0 and IWDᵢ<−3.5 are eliminated from further consideration, in this example. Also at 420, codes with WD<0 and IWDᵢ>+1.5 are eliminated from further consideration, in this example. For example, a code word of (+1, 0, +1, −1, −1, −½) has WD=−½and IWD=(+1, +1, +2, +1, 0, −½). Because IWDᵢ=+2 (in this example, for i=3), which exceeds the upper bound cutoff value of +1.5, this code would be eliminated from further consideration.

At 425, remaining code words with WD>0 are each paired with a symmetric code word having WD<0. As will be described further, in one example, encoder 110 maps each input 12-bit binary word into either: (a) a unique 6 PAM5 symbol code word having WD=0; or (b) a pair of symmetric 6 PAM5 symbol code words, one code word in the pair having WD>0, and its symmetric code word in the pair having WD<0. The particular code word in the pair that is actually communicated is selected to reduce toward baseline the cumulative disparity, which, in one example, is computed over the entire communication session, but which, in an alternative example, is computed over another period of interest.

### Example of Selecting Control Word(s)

After discarding particular ones of the possible codes, and pairing remaining codes with nonzero word disparities, as illustrated in FIG. 4, a set of valid candidate code words/pairs are obtained. In one example, but not by way of limitation, at least one of the valid candidate code words/pairs is reserved as a nondata “control” or “comma” word/pair, such as for synchronizing or aligning the data stream. Among other things, this allows the word boundaries of the words communicated over transmission line 105 to be mutually understood by transmitter is 115 and receiver 120, so that the received data can be properly decoded.

In a further embodiment, but not by way of limitation, the code word/pair is used to packetize or frame data, or to define a particular word that is in a known relationship to the comma as including a particular type of information. In one such illustrative example, the data word transmitted immediately after the comma word/pair is predefined to communicate control information about the communication session to receiver 120. Many other examples are possible.

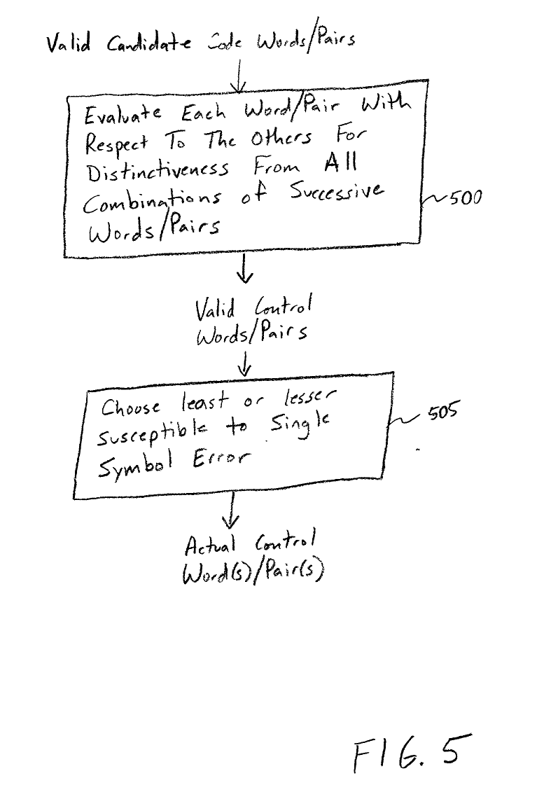

FIG. 5 is a flow chart illustrating generally, by way of example, but not by way of limitation, a method of selecting and designating one or more control/comma words/pairs. From the set of valid candidate code words/pairs provided by the method of FIG. 4, each word (if WD=0) or pair (if WD>0 or WD<0) is evaluated (using a computer program, or otherwise), at 500, with respect to all of the other words/pairs. Since, in one example, the control word will be decoded on a symbol-by-symbol basis to define word boundaries during the communication session, it must be distinguishable from all pairs of successively communicated data words/pairs.

For example, a valid code pair of the positive WD code word (−1, +1, +1, 0, −1, +1) and its symmetrical negative WD code word (+1, −1, −1, 0, +1, −1) would not be used as a control word if the valid code words/pairs also included (0, +½, +1, −1, −1, 0) and (+1, −1, 0, 0, +½, −½), because when these valid code words/pairs are communicated successively, the candidate control word (+1, −1, −1, 0, +1, −1) is found within the concatenated symbol stream of the successively-transmitted valid code words/pairs, as emphasized above.

At 505, the resulting distinctive words/pairs are then evaluated (using a computer program, or otherwise) for their susceptibility to one or more data transmission errors. In one example, this evaluation is performed to determine susceptibility to single-symbol error, that is, the likelihood that if one symbol is miscommunicated (e.g., takes on any erroneous signal-level due to noise), that it will be mistaken for one of the other valid code words/pairs. In one example, the control word(s)/pair(s) are selected as those candidates being least or less susceptible to single-symbol communication errors.

### Example of Selecting Actual Code Words/Pairs From Candidates

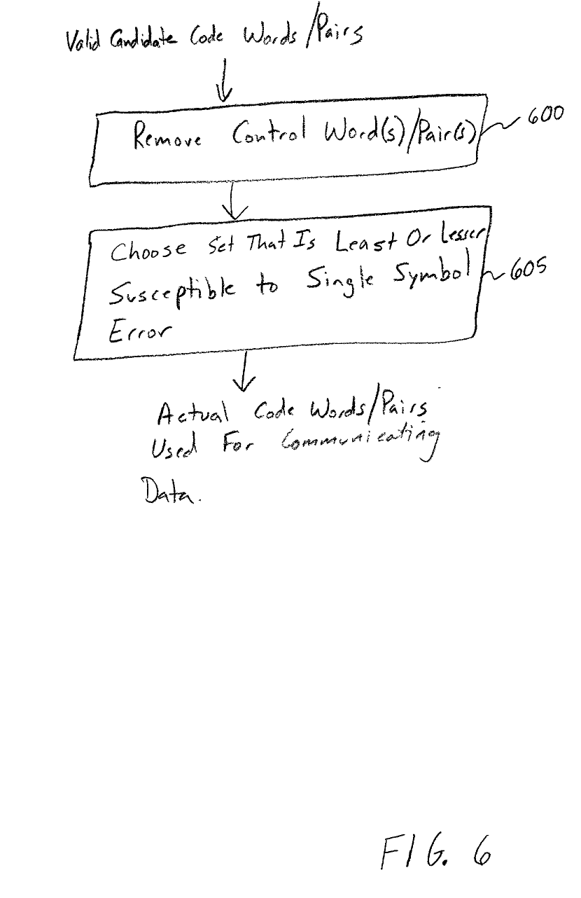

FIG. 6 is a flow chart illustrating generally, by way of example, but not by way of limitation, one technique for selecting actual code words for data communication from candidate valid code words obtained as illustrated in FIG. 4. At 600, the control word(s)/pair(s) are removed from further consideration as actual data communication code words, since these word(s)/pair(s) have already been reserved as nondata code word(s)/pair(s).

At 605, the remaining code words/pairs are then evaluated (using a computer program, or otherwise) for their susceptibility to one or more data transmission errors. In one example, this evaluation is performed to determine susceptibility to single-symbol error, that is, the likelihood that if one symbol is miscommunicated (e.g., takes on any erroneous signal-level due to noise), that it will be mistaken for one of the other remaining code words/pairs. In one example, the actual code word(s)/pair(s) are selected as those remaining code word(s)/pair(s) that are least or less susceptible to single-symbol communication errors.

### Examples of Encoder, Decoder, Or Codec

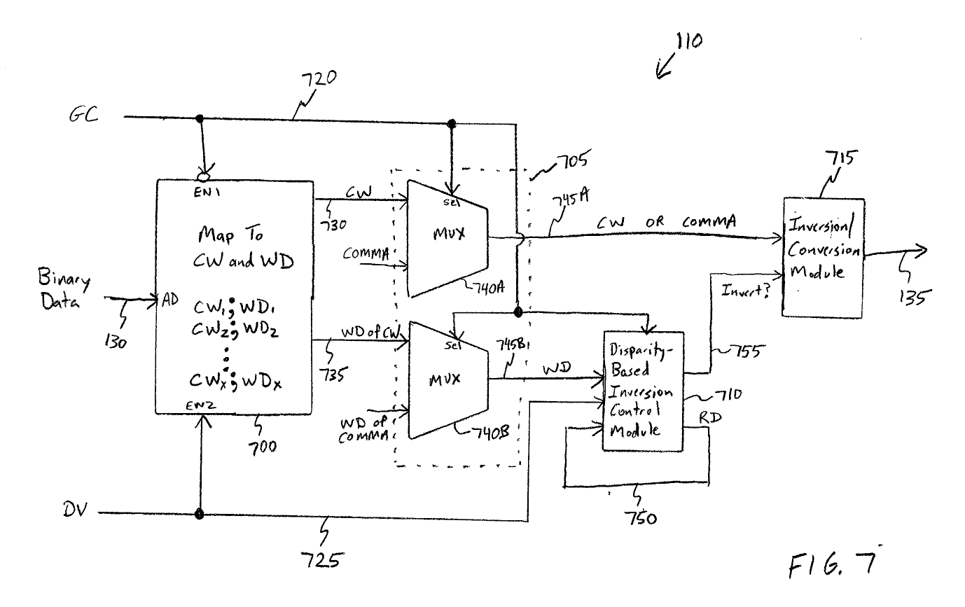

FIG. 7 is a schematic/block diagram illustrating generally, by way of example, but not by way of limitation, one example of portions of an encoder 110.

In general, encoder 110 is implemented for encoding n-bits of binary input data at node 130 into a m-symbol multilevel code word, however, for illustrative clarity, this example highlights the case where n=12, m=6, and a PAM5 multilevel signaling scheme is used. In this example, encoder 110 outputs, at node 135, a binary-encoded representation of the multisymbol multilevel code word, which is used by transmitter 115 to create the actual multilevel data signal communicated over transmission line 105.

In the example of FIG. 7, encoder 110 includes a map circuit 700, a code/comma selection circuit module 705, a disparity-based inversion control circuit module 710, and an inversion and/or conversion circuit module 715. In addition to the blocks of 12-bits (in this example) of binary data received at node 130, encoder 110 also receives a generate comma (“GC”) signal at node 720 and a data valid (“DV”) signal at node 725. Map 700 includes a ROM or other memory circuit for storing the actual code words (“CWs”) provided by the method of FIG. 6, together with the computed values of their corresponding word disparities, WD.

In this example, the CWs stored in map 700 include those CWs with WD=0 and those CWs with WD>0. Each CW with WD>0 is paired with a symmetric CW with WD<0, which is generated, if needed, by inversion/conversion module 715. (Alternatively, CWs with WD<0 are stored in map 700, and inverted, if needed, to generate corresponding symmetric CWS with WD>0). In this example, the actual CWS are stored in map 700 as binary-encoded representations of the 6 PAM5 symbols. Each PAM5 symbol, having 5 possible levels, is represented by 3 bits. Therefore, a 6 symbol PAM5 CW is represented by binary-encoding into 18 bits. In this example, the WD corresponding to each CW is represented by 3 bits. In this example, the mapping is performed by using the 12-bit binary input data at node 130 as an addressing input to the memory circuit of map 700. The GC and DV signals are used to respectively disable and enable the memory circuit of map 700. When the memory circuit is enabled, map 700 outputs the CW and corresponding WD at nodes 730 and 735, respectively.

In FIG. 7, the GC signal is also used as a control input to code/comma selection module 705, such as at “select” inputs of 2:1 multiplexers 740A-B. When the GC signal at node 720 is asserted, multiplexers 740A-B output the comma (i.e., a designated control word, stored in a corresponding register) and its corresponding WD (also stored in a register), respectively, at nodes 745A-B. Otherwise the CW and its associated WD are respectively output at these nodes.

Inversion control module 710 determines whether a CW should be inverted. It computes a deviation from baseline, or running disparity (“RD”), at node 750, by summing the WD of each encoded CW (or comma) over time. Based on the current RD and the WD of the CW (or comma) being encoded, an “Invert?” output is generated, at node 755, indicating whether the CW should be inverted, as illustrated in the example of Table 1. Inversion control module 710 also updates the RD by summing the WD of the CW (or comma) being encoded with the previously-stored RD.

The RD at 750 is initialized to zero (or other baseline), at each powerup. If desired, the RD at 750 is reset to zero after a desired time period, such as according to a protocol that is mutually understood by encoder 110 and decoder 125. In one example, the RD at 750 is reset to zero after each comma is encoded. In another example, the RD at 750 is reset to zero each time the DV signal at node 725 goes low (indicating invalid data). Alternatively, when the DV signal at node 725 goes low, the RD at 750 holds its previous value. Other control signal(s) may similarly be used to reset and/or hold the RD at 750 occasionally or periodically.

TABLE 1
Determining whether to invert CW
(or comma) based on WD and RD

| WD | RD | Invert? |
|---|---|---|
| 0 | X (“Don't Care”) | 0 = No |
| >0 | >0 | 1 = Yes |
| >0 | ≦0 | 0 |
| <0 | <0 | 1 |
| <0 | ≧0 | 0 |

If the “Invert?” control bit at node 755 is asserted, inversion/conversion module 715 inverts the CW (or comma) input at node 745 to substitute a symmetric multilevel 6 PAM5 symbol CW (or comma). As an illustrative example, a code word of (+½, +1, 0, −½, +½, 0) would be inverted into (−½, −1, 0, +½, −½, 0), which would be represented by 3 bits per PAM5 symbol, or a total of 18 bits per CW. In a further example, inversion/conversion module 715 further converts this binary-encoded 6 PAM5 symbol code word into a thermometer-encoded binary representation, at 135, of 4 bits per PAM5 symbol, or a total of 24 bits per CW. Table 2 illustrates one example of a thermometer-encoded binary representation of a PAM5 symbol using the signal levels illustrated in FIG. 2. This is useful, for example, where transmitter 115 includes a multilevel signal generator in which the multiple PAM5 levels are obtained using a thermometer-encoded binary input string.

TABLE 2
Example of thermometer-encoded binary-encoded PAM5 symbol

| PAM5 Level | Thermometer Code |
|---|---|
| +1 | 1111 |
| +½ | 0111 |
| 0 | 0011 |
| −½ | 0001 |
| −1 | 0000 |

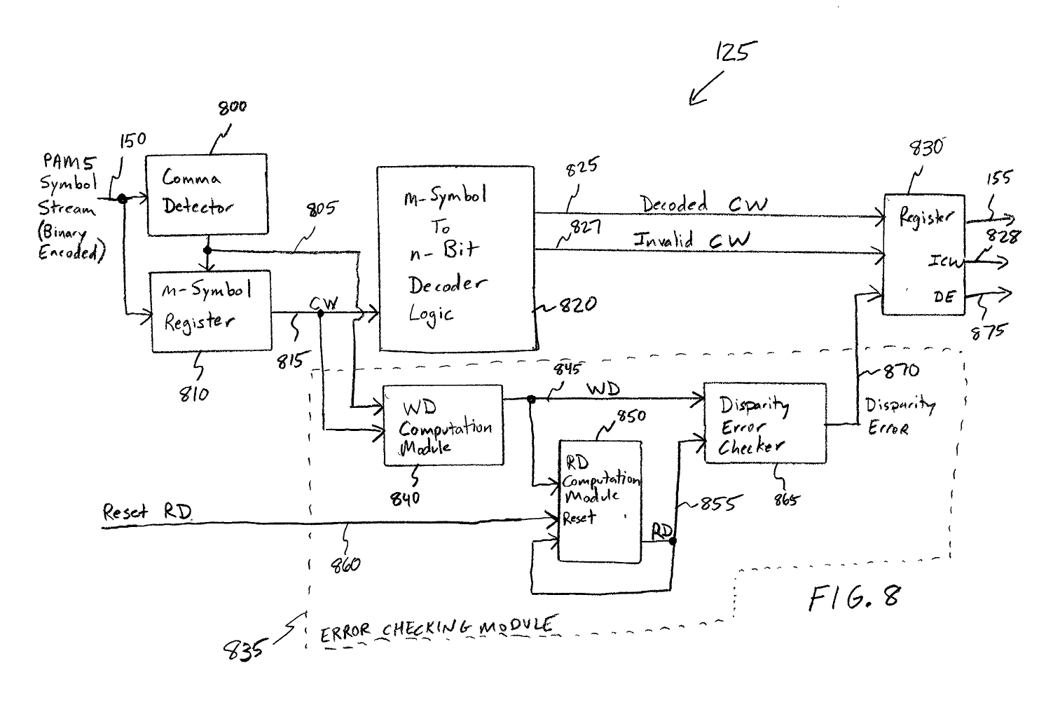

FIG. 8 is a schematic/block diagram illustrating generally, by way of example, but not by way of limitation, one example of portions of a decoder 125. In this example, decoder 125 includes an input, at node 150, that receives a binary-encoded PAM5 symbol stream (e.g., 3 bits per PAM5 symbol) output from receiver 125 based on the multilevel signals communicated over transmission line 105. A comma detector circuit 800 performs a symbol-by-symbol comparison of the most recently received m-symbols (e.g., m=6), which are binary-encoded, to a binary-encoded representation of the comma word. When a comma word is detected from the most recently received m-symbols, a responsive word alignment signal is output by comma detector 800 at node 805. Each subsequently-received group of binary-encoded m-symbols is interpreted as a CW, and stored in binary-encoded form in m-symbol register 810, unless and until a comma is again detected by comma detector 800.

In this example, the binary-encoded m-symbol CWS output at 815 by m-symbol register 810 are received at an input of m-symbol-to-n-bit decoder logic circuit 820. Decoder logic circuit 820 decodes each binary-encoded m-symbol CW into an n-bit binary representation. In one example, the m=6 symbol CWS, which are represented as binary-encoded into 18 bits, are decoded into n=12 bits that are output at node 825, stored in register 830, and, in turn, output at node 155. The decoder logic 820 maps each valid CW with a WD=0 to the same n-bit binary data word that was used, in FIG. 7, for addressing that CW in encoder map 700 at node 130. The decoder logic 820 maps symmetric pairs of valid CWS with a WD>0 or a WD<0 to the same n-bit binary data word that was used, in FIG. 7, for addressing, in encoder map 700, the CW of the pair having WD>0.

In one example, decoder 825 also includes an “Invalid CW” output, at node 827, which is asserted when the CW at 815 cannot be mapped to any one of the n-bit binary data words that were used, in FIG. 7, for addressing that same CW in encoder map 700 at node 130. The “Invalid CW” signal is input to and stored in register 830 along with the (invalid) decoded CW at node 825. The stored “Invalid CW” signal is output from register 830 at node 828.

In one embodiment, decoder 125 also includes an error checking circuit module 835. A WD computation circuit module includes an input that receives each CW, at node 815, and the CW alignment signal, at node 805. For each received CW, WD computation module 840 sums its PAM5 symbols' algebraic PAM5 signal levels (or sums their differences from the baseline value, if the baseline value is unequal to zero) to compute the WD. The WD computation module 840 outputs, at node 845, the computed WD, which is represented by a 3-bit binary code. The WD is received at one input of RD computation circuit module 850. After each CW, RD computation module 850 computes a new running disparity over a particular time period by summing the WD with the previously-stored RD. RD computation module 850 includes an output, at node 855, which provides the new RD.

RD computation module 850 includes a reset RD input, at node 860, for resetting the RD to zero at each powerup. If desired, the RD at node 855 is reset to zero after a desired time period, according to a protocol that is mutually understood by encoder 110 and decoder 125. In one example, the RD at node 855 is reset to zero after each comma is received. In another example, the RD at node 855 is reset to zero each time the Invalid CW signal at node 827 is asserted, indicating an invalid CW. Alternatively, when the Invalid CW signal at node 827 is asserted, the RD at node 855 holds its previous value. Other control signal(s) may similarly be used to reset and/or hold the RD at 855 occasionally or periodically.

In one example, disparity error checker circuit module 865 outputs, at node 870, a “Disparity Error” signal based on the WD at node 845 and the RD at node 855, each of which it receives at its inputs. The disparity error signal, at node 870, is asserted to indicate the presence of a disparity error if: (1) RD>0 and WD>0; or (2) RD<0 and WD<0. Otherwise, the disparity error signal, at node 870, is not asserted, indicating no disparity error is present. Disparity error checker 865 outputs the “Disparity Error” signal, at node 870, to be stored in register 830, along with the decoded CW at node 825. The stored “Disparity Error” signal is output from register 830 at node 875.

It is to be understood that the above description is intended to be illustrative, and not restrictive. For example, the above-discussed embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” “third,” etc. are used merely as labels, and are not intended to impose numeric requirements on their objects.

What is claimed is:

1. A data communication method including:
receiving an n-bit block of binary data;
encoding or decoding between the n-bit block of binary data and a representation of an m-symbol code word, each of the m-symbols in the code word including at least five possible values, each code word including:
at least one pair of adjacent symbols including a predetermined type of transition between different values of the symbols of the pair; and
a word disparity representing an cumulative deviation from a baseline of the values of the symbols of the code word, the word disparity being bounded within a predetermined range.

2. The method of claim 1, in which the encoding or decoding comprises each code word further including an intraword disparity representing a symbol-by-symbol cumulative deviation from baseline, within the code word, the intraword disparity bounded within a predetermined range.

3. The method of claim 2, in which the coding or decoding comprises:
each code word with a zero word disparity further including an intraword disparity bounded within a first predetermined range;
each code word with a positive word disparity further including an intraword disparity bounded within a second predetermined range;
each code word with a negative word disparity further including an intraword disparity bounded within a third predetermined range; and
in which each of the first, second, and third predetermined ranges includes at least one bound that is different from at least one bound of the others of the first, second, and third predetermined ranges.

4. The method of claim 3, in which, if the five possible values are represented as (−1, −½, 0, +½, +1),
the first predetermined range is between −1.5 and +1.5, inclusive;
the second predetermined range is between −1.5 and +3.5, inclusive; and
the third predetermined range is between −3.5 and +1.5, inclusive.

5. The method of claim 1, in which the predetermined range bounding the word disparity is between −2 and +2, inclusive.

6. The method of claim 1, in which the encoding or decoding includes encoding or decoding between a 12-bit block of binary data and a representation of a 6-symbol code word.

7. The method of claim 1, in which the encoding or decoding includes encoding or decoding between the n-bit block of binary data and a binary-encoded representation of the m-symbol code word.

8. The method of claim 1, in which the encoding or decoding includes an m-symbol code word in which the predetermined type of transition includes a symmetric about baseline transition.

9. The method of claim 8, in which the symmetric about baseline transition includes a symmetric about zero transition.

10. The method of claim 1, in which the encoding or decoding includes the five possible values represented as −1, −½, 0, +½, and +1.

11. The method of claim 10, in which the five possible values represented as −1, −½, 0, +½, and +1 respectively correspond to signal levels of about −100 mV, about −50 mV, about 0 V, about +50 mV, and about +100 mV.

12. The method of claim 1, further including communicating the m-symbol code word using pulse amplitude modulation.

13. The method of claim 1, in which the encoding or decoding comprises each m-symbol code word including:
a first bounded run length of the number of consecutive symbols, from the start of the code word, that do not include a transition of the predetermined type between adjacent ones of the symbols; and
a second bounded run length of the number of consecutive symbols, from the end of the code word, that do not include a transition of the predetermined type between adjacent ones of the symbols.

14. The method of claim 13, in which the encoding or decoding comprises each m-symbol code word includes at least one of:
a first bounded run length of at least six symbols and a second bounded run length of at least five symbols; and
a first bounded run length of at least five symbols and a second bounded run length of at least six symbols.

15. The method of claim 1, further including pairing m-symbol code words with an amount of positive word disparity with corresponding code words with the same amount of negative word disparity, each code word pair mapping to a unique code of the n-bit block of binary data, and each code word with zero word disparity mapping to a unique code of the n-bit block of binary data.

16. The method of claim 1, in which the pairing includes pairing code words with an amount of positive word disparity with corresponding symmetric code words with the same amount of negative word disparity.

15. The method of claim 1, further including using an m-symbol nondata code word.

16. The method of claim 15, in which the m-symbol nondata code word is distinct from all m-symbol strings of consecutive symbols in all combinations of concatenated pairs of other m-symbol code words.

17. The method of claim 15, in which the nondata code word is distinguishable from all other code words even if a transmission error occurs in one symbol of the nondata code word.

18. The method of claim 1, in which the encoding or decoding comprises each m-symbol code word used for communicating data selected to generally reduce susceptibility to a single-symbol error during communication.

19. The method of claim 1, further including communicating the m-symbol code word.

20. The method of claim 19, further including:
computing a running disparity, the running disparity representing a cumulative deviation from baseline over a period of interest; and
determining whether to invert the m-symbol code word, for the communicating, using the running disparity and the word disparity of the code word.

21. The method of claim 19, in which the determining whether to invert the m-symbol code word includes:
inverting the code word if the running disparity and word disparity are both postive; and
inverting the code word if the running disparity and word disparity are both negative.

22. The method of claim 21, in which the determining whether to invert the m-symbol code word further includes determining to not invert the code word otherwise.

23. The method of claim 19, further including error checking a received m-symbol code word using the running disparity and the word disparity.

24. The method of claim 19, further including communicating an m-symbol nondata code word for aligning word boundaries of received m-symbol code words to word boundaries of transmitted m-symbol code words.

25. A data communication apparatus including an encoder, the encoder including a map circuit, the map circuit including a first input configured to receive an n-bit block of binary data, and a first output configured to provide a representation of at least one corresponding m-symbol code word stored in the map, each of the m-symbols in the code word including at least five possible values, each code word including:
at least one pair of adjacent symbols including a predetermined type of transition between different values of the symbols of the pair; and
a word disparity representing an cumulative deviation from a baseline of the values of the symbols of the code word, the word disparity being bounded within a predetermined range, the word disparity stored in the map corresponding to the code word.

26. The apparatus of claim 25, in which each stored m-symbol code word includes an intraword disparity, representing a symbol-by-symbol cumulative deviation from baseline, within the code word, in which the intraword disparity bounded within a predetermined range.

27. The apparatus of claim 26, in which:
each code word with a zero word disparity further includes an intraword disparity bounded within a first predetermined range;
each code word with a positive word disparity further includes an intraword disparity bounded within a second predetermined range;
each code word with a negative word disparity further includes an intraword disparity bounded within a third predetermined range; and
in which each of the first, second, and third predetermined ranges includes at least one bound that is different from at least one bound of the others of the first, second, and third predetermined ranges.

28. The apparatus of claim 27, in which, if the five possible values are represented as (−1, −½, 0, +½, +1),
the first predetermined range is between −1.5 and +1.5, inclusive;
the second predetermined range is between −1.5 and +3.5, inclusive; and
the third predetermined range is between −3.5 and +1.5, inclusive.

29. The apparatus of claim 25, in which each stored m-symbol code word includes a word disparity bounded in a predetermined range between −2 and +2, inclusive.

30. The apparatus of claim 29, in which each stored m-symbol code word includes a word disparity bounded in a predetermined range between 0 and +2, and each stored m-symbol code word having positive word disparity also represents a corresponding symmetric m-symbol code word having negative word disparity.

31. The apparatus of claim 29, in which each stored m-symbol code word includes a word disparity bounded in a predetermined range between 0 and −2, and each stored m-symbol code word having negative word disparity also represents a corresponding m-symbol code word having positive word disparity.

32. The apparatus of claim 25, in which the first input of the map circuit is an addressing input configured to map a particular code of a 12-bit block of binary data to a binary-encoded representation of a 6-symbol code word stored in the map.

33. The apparatus of claim 25, in which the predetermined type of transition of the m-symbol code word includes a symmetric about baseline transition.

34. The apparatus of claim 33, in which the symmetric about baseline transition includes a symmetric about zero transition.

35. The apparatus of claim 25, in which each m-symbol code word stored in the map includes:
a first bounded run length of the number of consecutive symbols, from the start of the code word, that do not include a transition of the predetermined type between adjacent ones of the symbols; and
a second bounded run length of the number of consecutive symbols, from the end of the code word, that do not include a transition of the predetermined type between adjacent ones of the symbols.

36. The apparatus of claim 35, in which each m-symbol code word stored in the map includes at least one of:
a first bounded run length of at least six symbols and a second bounded run length of at least five symbols; and
a first bounded run length of at least five symbols and a second bounded run length of at least six symbols.

37. The apparatus of claim 25, in which the map pairs m-symbol code words with an amount of positive word disparity with corresponding code words with the same amount of negative word disparity, each code word pair mapping to a unique code of the n-bit block of binary data, and each code word with zero word disparity mapping to a unique code of the n-bit block of binary data, and in which only one of the code words in each code word pair is stored in the map.

38. The apparatus of claim 25, in which the map pairs code words with an amount of positive word disparity with corresponding symmetric code words with the same amount of negative word disparity.

39. The apparatus of claim 25, in which the encoder further includes a stored m-symbol nondata code word register, coupled to the first output of the encoder.

40. The apparatus of claim 39, in which the m-symbol nondata code word is distinct from all m-symbol strings of consecutive symbols in all combinations of concatenated pairs of other m-symbol code words.

41. The apparatus of claim 39, in which the nondata code word is distinguishable from all other code words even if a transmission error occurs in one symbol of the nondata code word.

42. The apparatus of claim 25, each m-symbol code word stored by the map is selected to generally reduce susceptibility to a single-symbol error during a communication.

43. The apparatus of claim 25, further including:
an inversion control circuit module, configured to compute a running disparity, the running disparity representing a cumulative deviation from baseline over a period of interest, the inversion control circuit module including an input coupled to the map to receive a word disparity of a code word, the inversion control circuit module configured to use the word disparity and the running disparity provide an inversion control signal at an output of the inversion control circuit module;
an inversion circuit module, including a first input coupled to the output of the inversion control circuit module to receive the inversion control signal, and including a second input coupled to the map to receive the code word, the inversion circuit module configured to invert the code word based, if indicated by the inversion control signal, and provide the resulting code word or inverted code word at a first output of the inversion module.

44. The apparatus of claim 43, in which the inversion control signal is configured to indicate that a particular code word should be inverted if the running disparity and word disparity are both postive, and is also configured to indicate that the particular code word should be inverted if the running disparity and word disparity are both negative, and is configured to indicate that the code word should not be inverted, otherwise.

45. The apparatus of claim 25, further including a transmitter, coupled to the first output of the encoder to receive a binary-encoded representation of the m-symbol code word and to transmit a resulting pulse-amplitude-modulated multilevel signal.

46. The apparatus of claim 25, in which the transmitter is configured to transmit the m-symbol code word using signal levels of about −100 mV, about −50 mV, about 0 V, about +50 mV, and about +100 mV.

47. A coder/decoder circuit including the apparatus of claim 25.

48. A data communication apparatus including a decoder, the decoder including a decoder input and a decoder logic map circuit, the map circuit including a first input configured to receive a representation of an m-symbol code word, the map circuit configured to map the m-symbol code word to an n-bit block of binary data provided at a first output of the map circuit, each of the m-symbols in the code word including at least five possible values, each code word including:
at least one pair of adjacent symbols including a predetermined type of transition between different values of the symbols of the pair; and
a word disparity representing an cumulative deviation from a baseline of the values of the symbols of the code word, the word disparity being bounded within a predetermined range, the word disparity stored in the map corresponding to the code word.

49. The apparatus of claim 48, in which each received m-symbol code word includes an intraword disparity, representing a symbol-by-symbol cumulative deviation from baseline, within the code word, and in which the intraword disparity bounded within a predetermined range.

50. The apparatus of claim 49, in which:
each code word with a zero word disparity further includes an intraword disparity bounded within a first predetermined range;
each code word with a positive word disparity further includes an intraword disparity bounded within a second predetermined range;
each code word with a negative word disparity further includes an intraword disparity bounded within a third predetermined range; and
in which each of the first, second, and third predetermined ranges includes at least one bound that is different from at least one bound of the others of the first, second, and third predetermined ranges.

51. The apparatus of claim 50, in which, if the five possible values are represented as (−1, −½, 0, +½, +1),
the first predetermined range is between −1.5 and +1.5, inclusive;
the second predetermined range is between −1.5 and +3.5, inclusive; and
the third predetermined range is between −3.5 and +1.5, inclusive.

52. The apparatus of claim 48, in which each received m-symbol code word includes a word disparity bounded in a predetermined range between −2 and +2, inclusive.

53. The apparatus of claim 48, in which the first input of the map circuit is configured to map a particular binary-encoded representation of a 6-symbol code word or pair to a particular code of a 12-bit block of binary data.

54. The apparatus of claim 48, in which the predetermined type of transition of the m-symbol code word includes a symmetric about baseline transition.

55. The apparatus of claim 54, in which the symmetric about baseline transition includes a symmetric about zero transition.

56. The apparatus of claim 48, in which each m-symbol code word includes:
a first bounded run length of the number of consecutive symbols, from the start of the code word, that do not include a transition of the predetermined type between adjacent ones of the symbols; and
a second bounded run length of the number of consecutive symbols, from the end of the code word, that do not include a transition of the predetermined type between adjacent ones of the symbols.

57. The apparatus of claim 56, in which each m-symbol code word includes at least one of:
a first bounded run length of at least six symbols and a second bounded run length of at least five symbols; and
a first bounded run length of at least five symbols and a second bounded run length of at least six symbols.

58. The apparatus of claim 48, in which the map decodes a pair of symmetric m-symbol code words with the same amount, but opposite algebraic sign, of word disparity into a unique code of the n-bit block of binary data.

59. The apparatus of claim 48, in which the decoder further includes:
a comma detector circuit, coupled to the decoder input to receive a stream of multilevel symbols, and configured to detect a particular m-symbol nondata code word;
an m-symbol register, coupled to the decoder input to receive the stream of multilevel symbols, and coupled to the comma-detector circuit to receive an indication of the detected particular m-symbol nondata code word, the m-symbol register including an output coupled to the input of the map for providing a word-boundary-aligned m-symbol data code word using alignment information triggered by the detected particular m-symbol nondata code word.

60. The apparatus of claim 59, in which the m-symbol nondata code word is distinct from all m-symbol strings of consecutive symbols in all combinations of concatenated pairs of other m-symbol code words.

61. The apparatus of claim 59, in which the nondata code word is distinguishable from all other code words even if a transmission error occurs in one symbol of the nondata code word.

62. The apparatus of claim 48, each m-symbol code mapped by the map is selected to generally reduce susceptibility to a single-symbol error during a communication.

63. The apparatus of claim 48, in which the decoder further includes a word disparity computation circuit module, coupled to the output of the m-symbol register, and configured to compute, and provide at an output, the word disparity of each m-symbol code word provided by the m-symbol register to the map.

64. The apparatus of claim 63, in which the decoder further includes a running disparity computation circuit circuit module, coupled to the output of the word disparity computation circuit module, to compute and provide at an output, a running disparity representing a cumulative deviation from baseline over a period of interest.

65. The apparatus of claim 64, further including a disparity error checker, coupled to and using the outputs of the word disparity computation circuit module and the running disparity computation circuit module to check for a disparity error of an m-symbol code word provided by the m-symbol register to the map.

66. The apparatus of claim 65, in which the disparity error checker includes an output indicating a disparity error, for a particular m-symbol code word provided by the m-symbol register to the map, if either: (a) the running disparity and word disparity are both positive; or (b) the running disparity and word disparity are both negative.

67. The apparatus of claim 48, further including a receiver, including an input configured to receive a multilevel representation of an m-symbol code word, and including an output configured to provide a binary-encoded representation of the m-symbol code word.

68. The apparatus of claim 67, in which the receiver is configured to receive the m-symbol code word using signal levels of about −100 mV, about −50 mV, about 0 V, about +50 mV, and about +100 mV.

69. A coder/decoder circuit including the apparatus of claim 48.
